(19) United States
(12) Patent Application Publication
(10) Pub. No.: US 2025/0259248 A1
(43) Pub. Date: Aug. 14, 2025

(54) SYSTEMS AND METHODS FOR MATCHING USERS IN A NETWORKING PLATFORM

(71) Applicant: JARROD KNOWLES, West Palm Beach, FL (US)

(72) Inventor: JARROD KNOWLES, West Palm Beach, FL (US)

(73) Assignee: TRUE COLORS DATING, LLC, West Palm Beach, FL (US)

(21) Appl. No.: 19/047,893

(22) Filed: Feb. 7, 2025

Related U.S. Application Data
(60) Provisional application No. 63/551,132, filed on Feb. 8, 2024.

(51) Int. Cl. G06Q 50/00

(52) U.S. Cl. CPC G06Q 50/01

(57) ABSTRACT

A method and associated system for matching users in a networking platform is disclosed. Initially, a request from a user is received that comprises a selection of one or more personality traits, and the received request is processed to generate a compatibility profile for the user. Further, a compatibility request is received from the user upon generating the compatibility profile and an assessment report is generated for the user based on the received compatibility request.

### FIELD OF THE INVENTION

The present invention relates generally to networking systems and, more specifically, to networking systems and methods for matching users in a networking platform.

### BACKGROUND OF THE INVENTION

In recent years, networking platforms such as social and dating applications, have seen widespread use for relationship building. Traditional networking platforms typically allow users to create profiles, answer a set of pre-defined questions, and match with other users based on mutual interests or preferences. While the traditional networking platforms have provided a means for connecting users, they often fall short in several key areas such as personalization, user safety, spontaneous interactions, and quality control over engagement locations.

Platforms have been created for matching one person with another, often referred to as “dating apps.” These applications typically are subscriber based and have one person upload certain information about them, including for example, their hobbies, interest, and photographs of them to create a user profile. Other participants on the platform have the ability to review several user profiles and select one or more that interest them. If there is a match, the platforms allow the two users to interact via an electronic messaging service. A draw back to these dating apps in existence is that they fail to assess true compatibility between two people based on their unique personality traits, often resulting in short-termed, failed relationships.

While personality tests have been used in various settings, the process can be time consuming and cumbersome. Often a person has to answer a series of questions before a compatibility report can be generated. There is a need for an easy-to-use dating application that evaluates the matchmaking process based on compatible personality traits.

Another problem with existing dating applications is that the user must be able to utilize their fingers to “swipe” left or right to either accept or reject a potential match. Accordingly, there is a need for a dating application that can be utilized by those with disabilities who may not have use of their hands.

### SUMMARY OF THE INVENTION

The disclosed matchmaking method and system provides a solution to the aforementioned problems and needs existing in the prior art. Specially, the disclosed invention provides a system enabling users to communicate over a network and be “matched” based on inputted personality traits and AI generated compatibility assessments. Additionally, the disclosed system provides for voice-activation commands that enables a user to navigate the prompts of the system and issue commands without the need of using his or her hands.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 shows a block diagram of a networking system in accordance with some embodiments of the present disclosure;

FIG. 2 shows a detailed block diagram illustrating a matching engine in accordance with some embodiments of the present disclosure;

FIG. 3 shows a flow diagram of an example matching method in accordance with some embodiments of the present disclosure;

FIG. 4 shows a schematic representation of an example computer-readable storage medium in accordance with some embodiments of the present disclosure;

FIG. 5 shows a flow chart showing an overview of one embodiment of AI compatibility assessment in accordance with some embodiments of the present disclosure;

FIG. 6 shows an AI-generated relationship compatibility summary created by the matching engine 102 in accordance with some embodiments of the present disclosure;

FIG. 7 shows an example of the personality traits displayed on the interface of a user device in accordance with some embodiments of the present disclosure;

FIGS. 8A-8B shows an example of a user's profile in accordance with some embodiments of the present disclosure;

FIG. 9 shows an example of an assessment report generated by the matching engine in accordance with some embodiments of the present disclosure;

FIG. 10 shows a flow diagram showing an overview of the voice activation functionality in accordance with some embodiments of the present disclosure; and

FIGS. 11A-11D shows example representations of example user interfaces along with a voice input displayed on the user device in accordance with some embodiments of the present disclosure.

Like reference numerals refer to like parts throughout the several views of the drawings.

### DETAILED DESCRIPTION

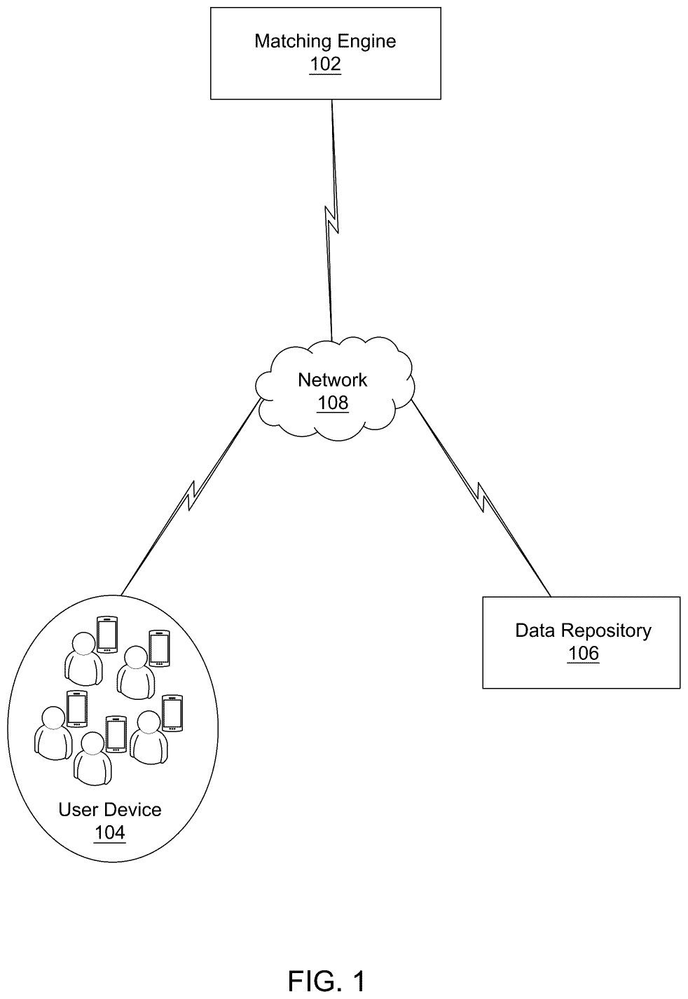

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

Referring initially to FIG. 1, which shows an example networking system 100 in accordance with some embodiments of the present disclosure. As illustrated in FIG. 1, the example networking system 100 comprises a matching engine 102, a user device 104, and a data repository 106. The matching engine 102, the user device 104, and the data repository 106 are coupled via a network 108.

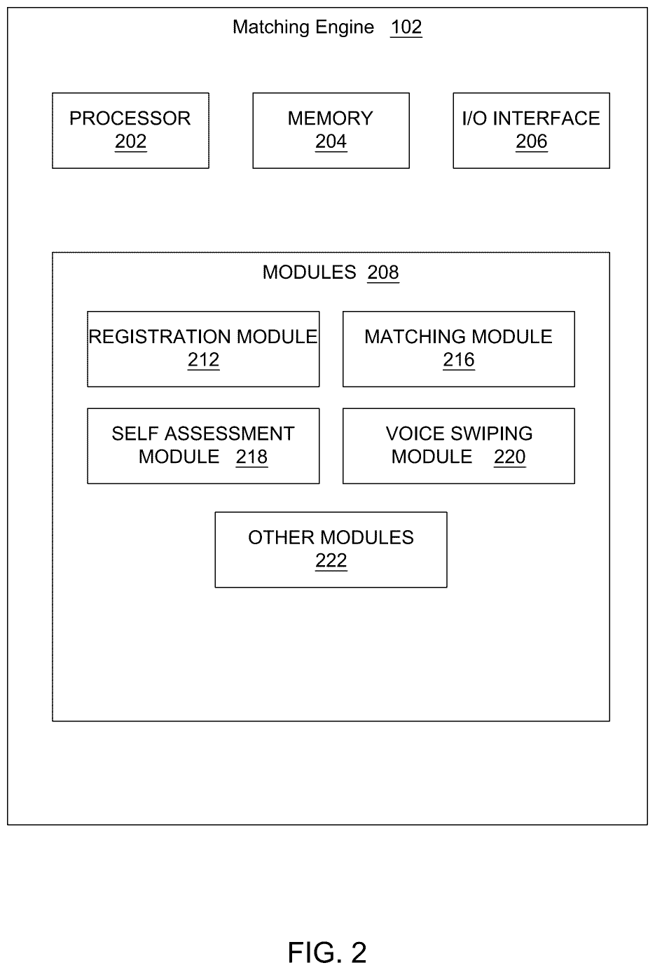

The networking system 100 comprises the matching engine 102, which serves as a central component responsible for registering users, creating compatibility profiles, processing compatibility requests, and generating assessment reports. In some embodiments, the matching engine 102 may utilize machine learning algorithms, natural language processing, and artificial intelligence tools to analyze compatibility between users. Further, the matching engine 102 may also recommend compatible users based on a self-assessment report generated for a user. As will be discussed in more detail in relation to FIG. 2, the matching engine 102 comprises several key components that work together to ensure efficient matching between the users.

Further, the networking system 100 comprises the user device 104. The user device 104 is an end-user device that interfaces with the matching engine 102 to register the users with a networking platform provided by the matching engine 102. While registering the users, the user device 104 enables the users to submit personality trait selections, request compatibility assessments, and receive assessment reports generated by the matching engine 102. The user device 104 may be any electronic device capable of streaming media, such as a desktop computer, laptop, smartphone, tablet, or smart TV.

In some embodiments, the user device 104 comprises the networking platform to connect with the matching engine 102. In some embodiments, the networking platform may be a software application installed in the user device 104, a web application that may be accessed through a web browser associated with the user device 104, or an Original Equipment Manufacturer (OEM) software.

The networking system 100 also comprises the data repository 106. The data repository 106 is configured to store information related to registered users, including personality traits, compatibility profiles, and historical interaction data. Additionally, the data repository 106 maintains information on users' social media activity, location history, and personal details, which may be utilized by the matching engine 102 to enhance compatibility assessments. In some embodiments, the data repository 106 may be integrated within the matching engine 102. In some other embodiments, the data repository 106 may be a standalone repository communicatively coupled with the matching engine 102 over the network 108.

The networking system 100 also comprises the network 108 that may be a LAN (local area network), WAN (wide area network), wireless network, point-to-point network, or another configuration. One of the most common types of the network 108 in current use is a TCP/IP (Transfer Control Protocol and Internet Protocol) network for communication between different devices. Other common Internet protocols used for such communication include HTTPS, FTP, AFS, and WAP and using secure communication protocols etc. In some embodiments, the network 108 may be any type of communication network, including one or more of the Internet, local area networks (LAN), wireless networks, switch or hub connections, a telephone network (e.g., a public switched telephone (PSTN) network, a cellular network, or the like), or the like.

It is to be noted that though FIG. 1 shows a single matching engine 102, a single user device 104, and a single data repository 106; a person skilled in the art would appreciate the networking system 100 may comprise a plurality of such devices, which are not shown herein for the sake of brevity.

FIG. 2 shows a detailed block diagram illustrating the matching engine 102 in accordance with some embodiments of the present disclosure.

The matching engine 102 (also known as a matching server) is a pivotal component within the networking system 100, configured to facilitate the processing of data for generating an assessment report between users. In an implementation, the matching engine 102 may comprise a processor 202, a memory 204, an I/O interface 206, and one or more modules 208. The matching engine 102 may host the networking platform (also known as an application).

The processor 202 may be configured to perform one or more functions to fulfill one or more requirements of the matching engine 102. The memory 204 may be communicatively coupled to the processor 202 and may store necessary information for the operation of the matching engine 102. In some embodiments, the memory 204 may be configured to maintain a record that comprises a compatibility profile of each user registered with the matching engine 102. The I/O interface 206 may be configured to enable the matching engine 102 to communicate with one or more devices, such as the user device 104 or any external device. In some embodiments, the I/O interface 206 may be an Application Program Interface (API).

In some implementations, the matching engine 102 may comprise the one or more modules 208 for performing various operations in accordance with some embodiments of the present disclosure. In some embodiments, the one or more modules 208 may be stored as a part of the processor 202. In some other embodiments, the one or more modules 208 may be communicatively coupled to the processor 202 to perform one or more functions of the matching engine 102. The one or more modules 208 may comprise, without limiting to, a registration module 212, a matching module 216, a self-assessment module 218, a voice swiping module 220, and other modules 222.

As used herein, the term module refers to an application-specific integrated circuit (ASIC), an electronic circuit, a processor (shared, dedicated, or group) and memory that executes one or more software or firmware programs, a combinational logic circuit, and/or other suitable components that provide the described functionality. In an embodiment, the other modules 222 may be used to perform various miscellaneous functionalities of the matching engine 102. It would be appreciated that such other modules 222 may be represented as a single module or a combination of different modules.

In some examples, the processor 202 may comprise at least one controller in communication with at least one non-transitory processor-readable medium. The processor- readable medium may have instructions stored thereon which when executed cause the processors to perform or control performance of the operations as described herein. Furthermore, in some examples, the processor 202 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

The one or more modules 208 comprises the registration module 212. The registration module 212 is configured to register one or more users with the matching engine 102 and manage the registered accounts to enable one or more registered users to access one or more features provided by the matching engine 102 upon receiving a request from the user device 104.

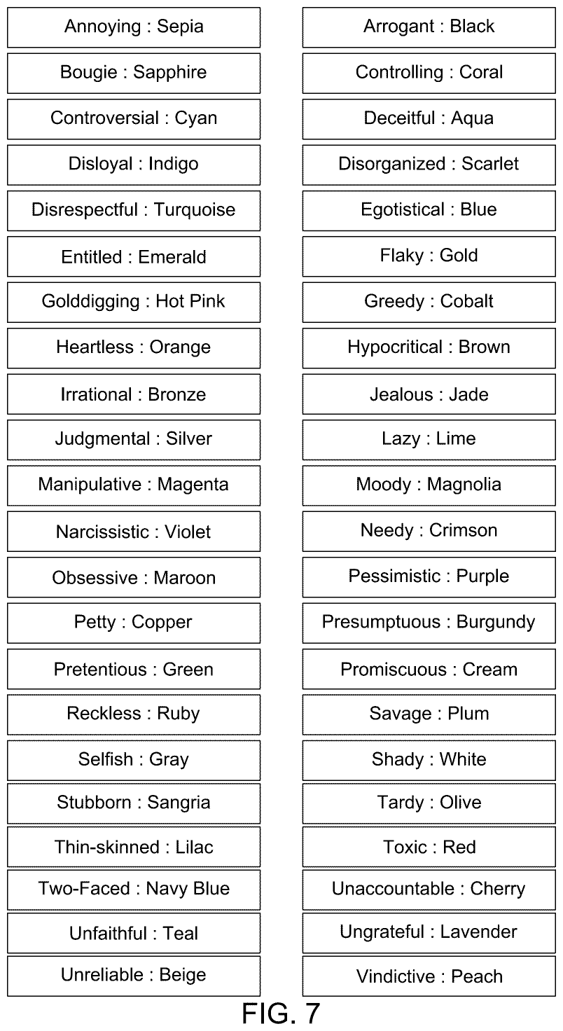

During the registration process, the registration module 212 is configured to collect necessary information such as username, email address, and other unique identifiers associated with the user. This information is securely stored in the data repository 106 or in the memory 204. Upon registering the user, the registration module 212 is configured to generate unique login credentials for the user. Further, the registration module 212 is configured to receive a user selection of one or more personality traits from a set of 48 predefined personality traits. In some embodiments, the user needs to select at least three personality traits. In some embodiments, the personality traits are also referred to as true colors. As shown in FIG. 7, an example list of the available personality traits and colors associated with each trait may be displayed on a user interface of the user device 104. The user can select one or more personality traits through the interface to create a user profile. In a preferred embodiment, the user selects a minimum of three (3) traits out of the forty-eight (48) listed traits. Each personality traits correspond to a toxic personality trait mapped to a Big Five personality model, which is used for checking compatibility between the users. In some embodiments, the Big Five personality model includes Openness, Conscientiousness, Extraversion, Agreeableness, and Neuroticism.

By selecting the personality traits, the registration module 212 is configured to create and register a dynamic compatibility profile, which serves as the foundation for the compatibility assessment. In some embodiments, the personality traits are provided on a user interface associated with the user device 104. In some other embodiments, the personality traits are provided through the audio interface to the user device 104.

In some other embodiments, in order to generate the compatibility profile, the registration module 212 is configured to provide one or more compatibility questions to the user through the user device 104. In some embodiments, the one or more compatibility questions correspond to the personality traits. Upon providing the one or more compatibility questions, the registration module 212 is configured to receive a response from the user to the one or more compatibility questions. Upon receiving the response from the user, the registration module 212 is configured to generate the compatibility profile for the user based on the response from the user.

In some embodiments, the one or more compatibility questions are a pre-defined set of questions. In some other embodiments, the one or more compatibility questions are dynamically generated using an artificial intelligence algorithm incorporated within the registration module 212 using an initial set of questions.

The registration module 212 is also configured to manage the ongoing authentication of users. When a user attempts to log in, the registration module 212 is configured to verify the login credentials against the stored information in the data repository 106 or in the memory 204. In some embodiments, verifying the login credentials comprises checking the provided username and password to ensure they match the records in the data repository 106 or in the memory 204. If the credentials are valid, the user is granted access to the matching engine 102.

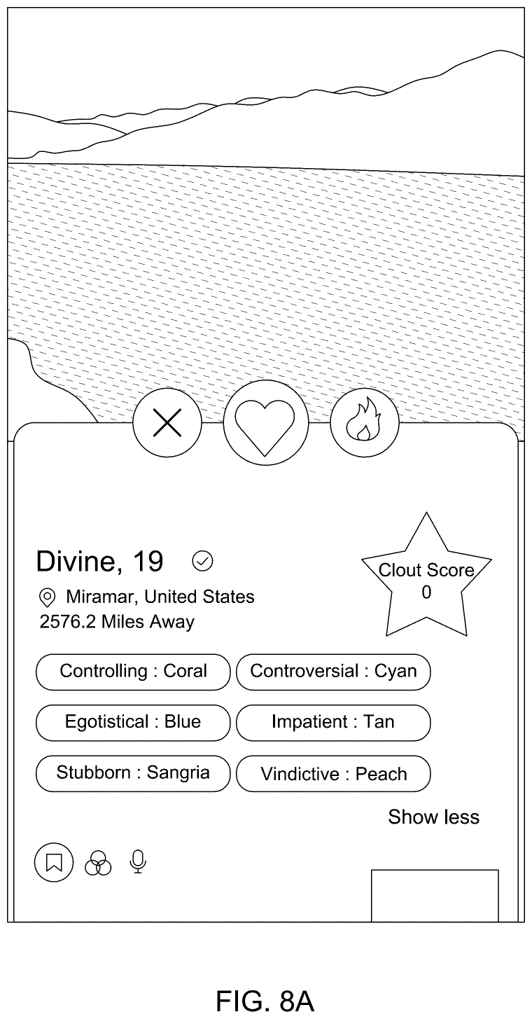

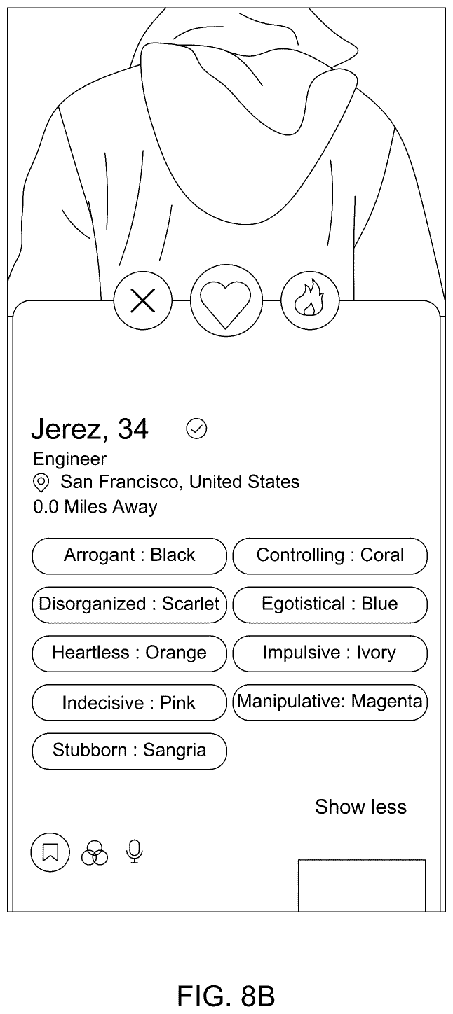

Upon selection of the required personality traits, the user may register his or her profile and gain access to other registered user profiles that are available for public view. Additional information may be uploaded by the user, including photographs. An example of a depiction of a user's profile is shown in FIG. 8A and another user's profile is shown in FIG. 8B.

The one or more modules 208 also comprises the matching module 216. The matching module 216 is configured to match the user with at least one other user based on their compatibility profiles. In order to match the user with the at least one other user, the user matching module 216 is configured to initially receive a matching request from the user. In some embodiments, the matching request is received when the user hovers over the profile of the at least one other user and selects a matching request icon displayed on the profile. In some embodiments, the matching request is also known as a compatibility request.

Upon receiving the matching request, the matching module 216 is configured to retrieve the compatibility profiles of both the user and the at least one other user. Further, the matching module 216 is configured to retrieve additional information, such as user preferences, behavioral patterns, and user information. Upon retrieving the compatibility profiles and the additional information, the matching module 216 is configured to generate an assessment report for the user based on the received matching request. In some embodiments, the matching module 216 may employ machine learning algorithms, natural language processing algorithms, and advanced artificial intelligence tools to generate the assessment report.

In some embodiments, in order to generate the assessment report, the matching module 216 is configured to determine a correlation between the user and the at least one other user using the retrieved compatibility profiles and the retrieved additional information. In some embodiments, the correlation is determined for each personality attribute for the Big Five personality model using the personality trait information. In some embodiments, the matching module 216 may assign weights to each personality attribute which may be dynamically adjusted based on one or more factors.

Further, the matching module 216 is configured to generate compatibility analysis by processing the determined correlation to the natural language processing algorithms. Using the generated compatibility analysis, the matching module 216 is configured to generate the assessment report, which is also known as a summary report.

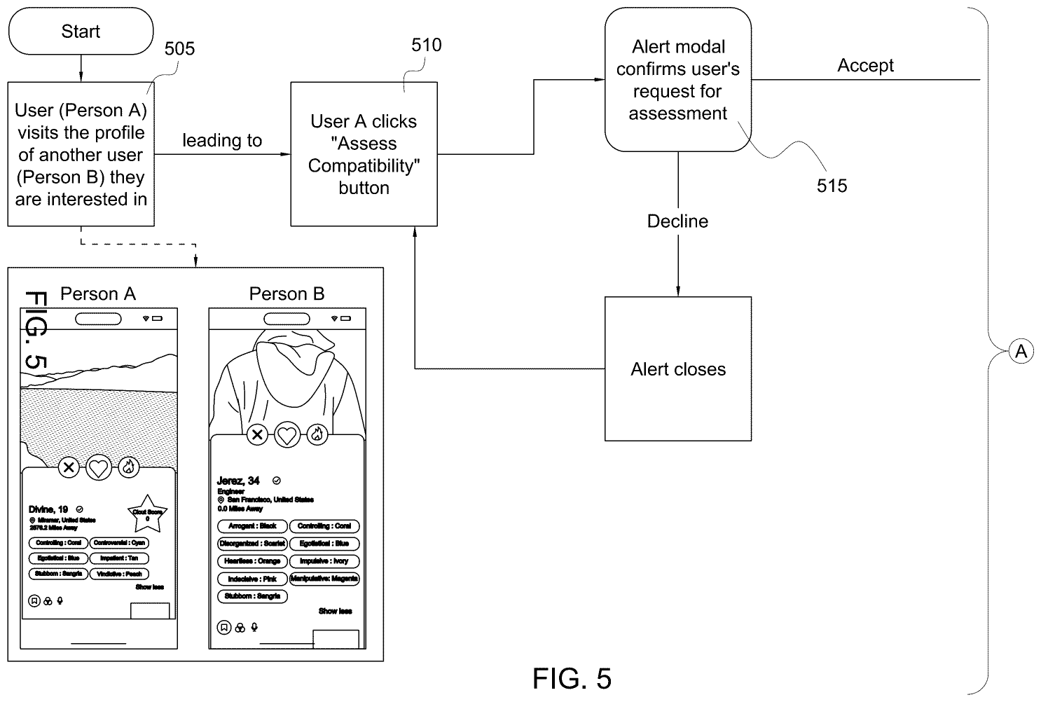

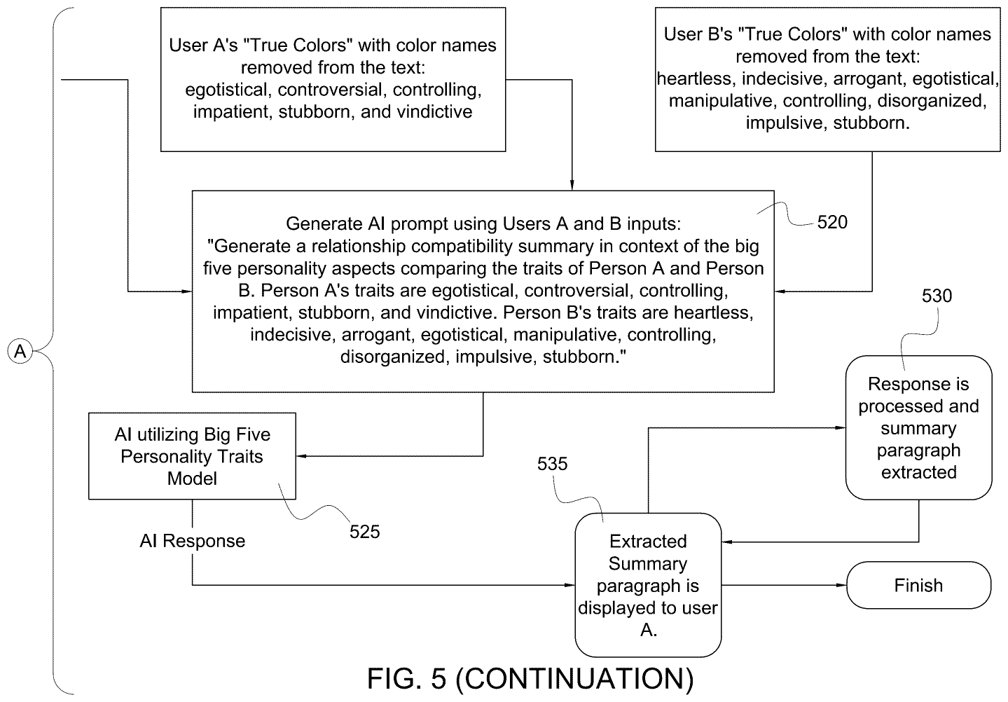

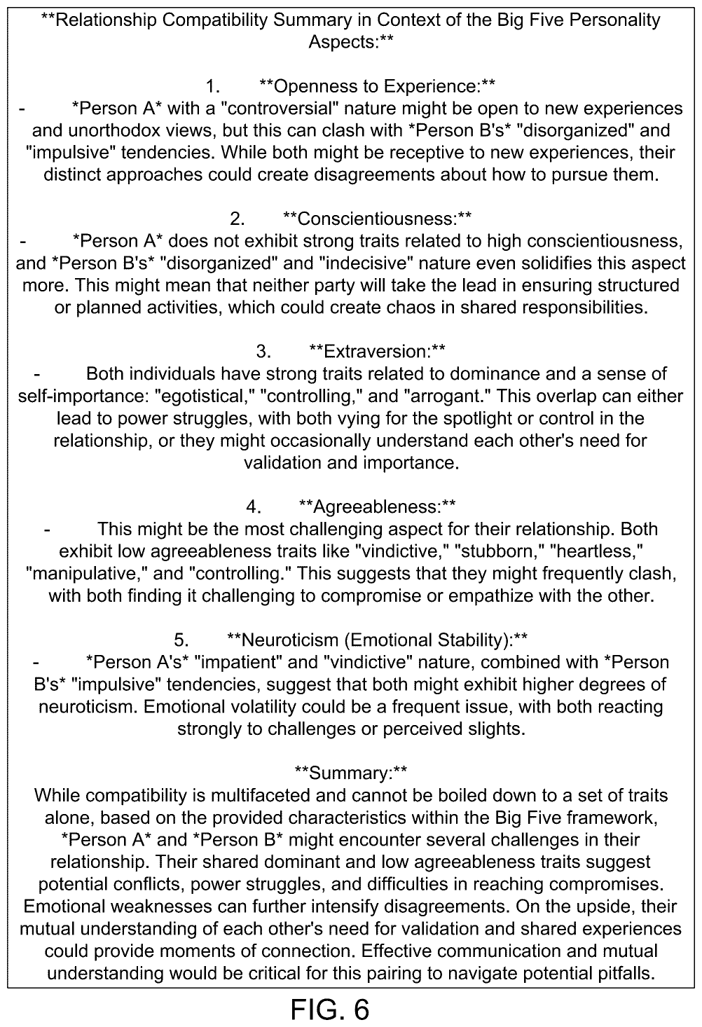

In the preferred embodiment, the matching module 216 includes machine learning artificial intelligence (AI) operable to perform a comparative analysis of compatibility between two users based on their selected traits. An embodiment of the capability assessment method is depicted in FIG. 5. The AI is trained to categorize each trait under one or more of the five (5) domains of the Big 5 (a.k.a. 5 Factor) Model. The “Big Five” or Five Factors refers to the five major personality dimensions that psychologists have determined are core to our individual personality makeup. The Big Five personality traits are: (i) Openness—How open a person is to new ideas and experiences; (ii) Conscientiousness—How goal-directed, persistent, and organized a person is' (iii) Extraversion—How much a person is energized by the outside world; (iv) Agreeableness—How much a person puts others' interests and needs ahead of their own; and (v) Neuroticism—How sensitive a person is to stress and negative emotional triggers. The AI is operable to generate a compatibility assessment of two individuals based on their listed personality traits. An embodiment of the capability assessment method is depicted in FIG. 6. In some embodiments, the one or more personality traits are categorized into multiple domains, where each domain corresponds to a particular aspect of personality, also known as personality dimensions or big five personality traits.

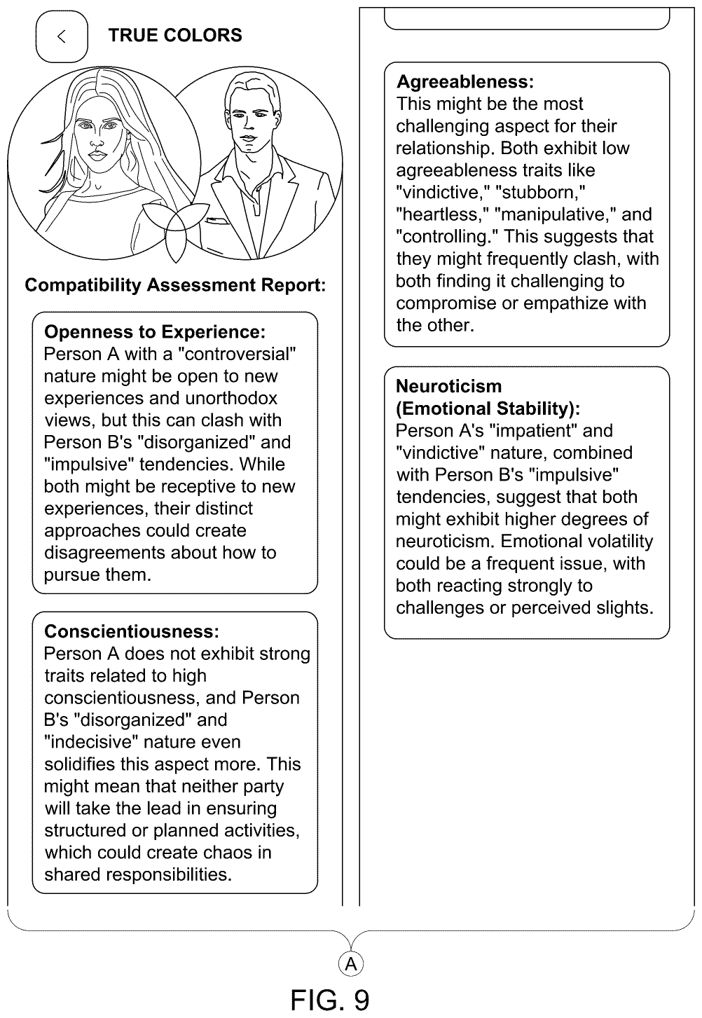

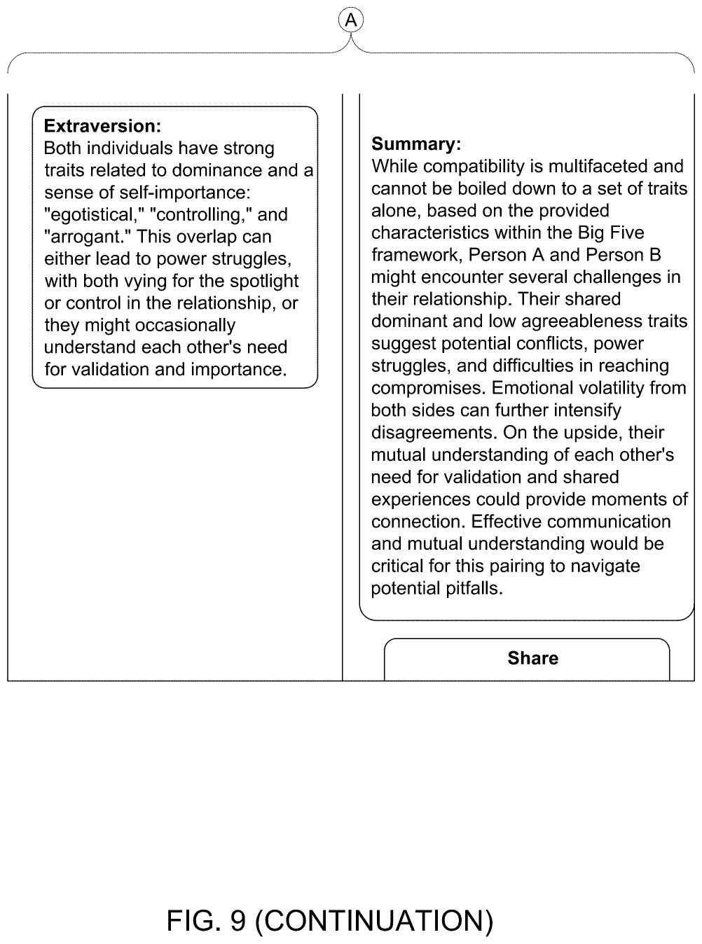

The user may generate a compatibility assessment (also known as an assessment report) that assesses the compatibility of themselves and another user. When viewing the profiles of other users, an icon exists that, when selected by the user on the user interface, generates a compatibility assessment for themselves and the current profile. The matching engine 102 then transmits this compatibility assessment to the user device 104 and a report can be accessed through the interface in accordance with the method depicted in FIG. 5. An example compatibility report is shown in FIG. 9. The assessment report may provide a grade, score, or description of the overall compatibility of the two users. The assessment report may also provide a detailed analysis of which personality traits are compatible, which personality traits may clash and whether the two users would or would not be a good match. Further, the report may include details and analysis regarding which aspects of dating, communication, relationships, etc. that two users are likely to have success in and which aspects may be more challenging.

Turning to FIG. 5, after a user has initiated the “compatibility assessment” function, the application may send a request (such as an Application Programming Interface (API) request) which is ultimately received by the machine learning artificial intelligence (AI) located on the matching engine 102. The request includes the personality traits of both users. The request may be in the form of a prompt. The prompt may be written in form that is compatible with a generative AI. For example, a prompt may state, “Generate a relationship compatibility summary in context of the big five personality aspects comparing the traits of Person A and Person B. Person A's traits are egotistical, controversial, controlling, impatient, stubborn and vindictive. Person B's traits are heartless, indecisive, arrogant, egotistical, manipulative, controlling, disorganized, impulsive, stubborn.” The AI then generates a report using the Big Five Personality Traits model. After the detailed report is generated, a summary paragraph is extracted from the AI answer and displayed to the user. In some embodiments, the report and/or summary may be shared with the other subject user, a 3^{rd} party or on social media. In some embodiments, the full and un-summarized report may be accessed by the requesting user.

In some embodiments, the application interfaces with a 3rd party, general purpose AI. In some embodiments, the application interfaces with a function-specific AI. The application may further include a “self-assessment” functionality. The “self-assessment” functionality is operable to use AI to provide an analysis of the user's individual personality and dating profile based on user's selected personality traits.

The analysis may provide an evaluation of the user's compatibility as it relates to romantic relationships, friendships, and business relationships, etc. Based on the user's personality traits the “self-assessment” function explains the traits or groups of traits that user is most compatible with as well as the traits they are least compatible with. The assessment can inform users with which type of people and personality traits they are most drawn to as well as the types of personalities, people and traits that may be more challenging to interact with. Users can use this information to better select potential partners through the application as well as in the user's day-to-day life. The process of generating a report via AI is the same as the “compatibility assessment” except that the requests only include one set of traits and requests the AI generate an assessment of a single person.

As discussed above, one user, after inputting his or her traits and other requested data, is permitted to register a user profile in the system and gain access to other user profiles via the network. The user device 104 may be equipped with GPS tracking that would allow the network to filter available user profiles based on geographic location. Other filtering software may also be included to narrow the pool of available user profiles that can be seen on the network by any one user. If a user is interested in another user, he or she may activate a prompt on their interface that initiates a compatibility assessment. A secondary confirmation may be incorporated at this step to ensure the user desires a compatibility assessment. Upon confirmation, a prompt template is populated based on the selected traits of each user. The prompt is communicated from the matching engine 102 to the AI for processing. The matching engine 102 can then communicate the compatibility report results back to the requesting user device 104 and the results can be viewed on the module's interface.

In some embodiments, the application may be operable to list available profiles to a user based on compatibility with the user. For example, the application may suggest profiles with the most compatible profiles listed first. In some embodiments, the application allows users to filter available profiles based on certain personality traits, or compatibility scores or other metrics.

The one or more modules 208 also comprises the self-assessment module 218. The self-assessment module 218 is configured to generate a self-assessment report for the user. Using the generated self-assessment report, the self-assessment module 218 is also configured to provide a recommendation to the user that may comprise a group of users that are compatible with the user and another group of users that are not compatible with the user. For example, upon generating the self-assessment report for User A, the self-assessment module 218 may provide a recommendation that User B is likely to match with User A and User C is not likely to match with User A. In order to generate the self-assessment report, the self-assessment module 218 is configured to receive a self-assessment request for the user.

In some embodiments, the self-assessment request is received when the user selects a self-assessment icon provided on the user device 104. Upon receiving the self-assessment request, the self-assessment module 218 may perform an analysis of the compatibility profile of the user. Further, in some embodiments, the self-assessment module 218 is configured to retrieve previous interactions, communication styles, and interaction tendencies and use the same to perform the analysis.

Based on the analysis, the self-assessment module 218 is configured to generate the self-assessment report, which comprises recommended users that are matching and to avoid. Further, the self-assessment report may also provide suggestions to improve the compatibility profile of the user by providing various recommendations, such as anger management, yoga, meditation, or the like.

The one or more modules 208 also comprises the voice swiping module 220. The voice swiping module 220 is configured to revolutionize the way users navigate and interact with potential matches by integrating voice commands and audio-based interactions into the matchmaking process. Further, the voice swiping module 220 is configured to allow the user to browse through profiles, express interest, and initiate conversations using hands-free voice controls, offering a more intuitive and engaging user experience.

Instead of traditional swipe gestures or text-based browsing, the voice swiping module 220 enables the users to simply speak commands to explore matches. For example, users can say, “Next profile,” “Show more details,” or “Like this match” to seamlessly navigate through potential connections, which is particularly beneficial for users who prefer a more interactive and accessible way of using the platform, allowing for a smooth, effortless matchmaking experience.

Further, the voice swiping module 220 may be configured to facilitate pre-message audio interactions. Before engaging in text-based conversations, the user may exchange short voice clips or engage in real-time voice chats to gauge compatibility through tone, personality, and verbal expression, which may be used as additional input for matching the user with the at least one other user or for the self-assessment analysis.

Further, the voice swiping module 220 may be configured to leverage AI-driven voice recognition technology to analyze speech patterns, tone, and sentiment. Using the above feature, the matching engine 102 may offer personalized recommendations based on user interactions. For example, if a user frequently engages in voice chats with expressive and outgoing individuals, the matching engine 102 may suggest more extroverted matches. Additionally, speech sentiment analysis helps the matching engine 102 to detect enthusiasm, compatibility cues, and conversational chemistry, refining matchmaking accuracy. By enabling voice-based interactions, voice swiping module 220 enhances accessibility for users with visual impairments or those who prefer hands-free browsing. The voice swiping module 220 also provides a more engaging alternative to traditional swiping, reducing screen fatigue while making the process more natural and enjoyable.

The one or more modules 208 may also comprise the other modules 222 to perform various miscellaneous functionalities of the matching engine 102. It will be appreciated that such aforementioned modules may be represented as a single module or a combination of different modules. The modules may be implemented in the form of software implemented by a processor, hardware, and or firmware.

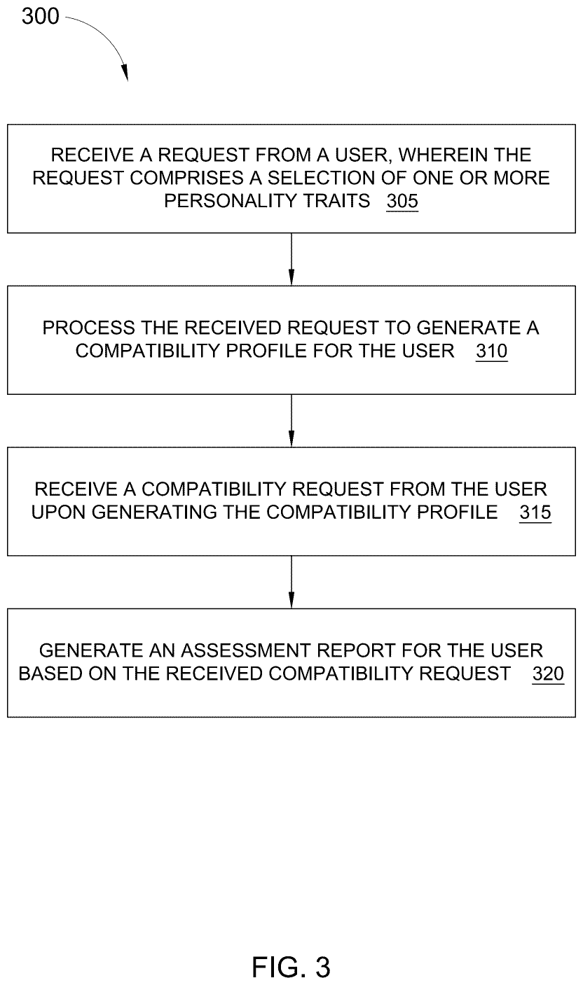

FIG. 3 is a flow diagram of an example user matching method in accordance with some embodiments of the present disclosure. As illustrated in FIG. 3, the method 300 comprises one or more blocks implemented by the matching engine 102. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 305, a user submits a request to the matching engine 102, wherein the request comprises a selection of one or more personality traits. In some embodiments, the user submits the request through a user device 104, and the request is processed by the registration module 212.

During the request submission process, the registration module 212 collects necessary information such as the selected personality traits. The received data is securely stored in the data repository 106. In some embodiments, the request may be an audio input processed by an audio interface to enhance the user experience.

At block 310, a compatibility profile for the user is generated. In some embodiments, the compatibility profile is generated by the registration module 212 using a combination of user responses and data extracted from external sources, including social media activity, location history, and personal information. The compatibility profile is unique to each user and may specify preferences, interests, and compatibility attributes.

At block 315, a compatibility request is received from the user. In some embodiments, the compatibility request comprises a self-assessment request or a selection of a target user for matching. The request is processed by the matching module 216.

At block 320, the matching engine 102 processes the compatibility request and generates an assessment report. In some embodiments, the assessment report includes a first group of users that are compatible with the requesting user and a second group of users that are not compatible with the user. In some other embodiments, the assessment report may include a compatibility summary between the user and the target user. The assessment report is generated using machine learning algorithms by analyzing compatibility profiles and determining correlations between the user and potential matches from the analysis. The correlation data is further processed using natural language processing to generate a compatibility analysis. The final assessment report is based on both the determined correlation and the generated compatibility analysis.

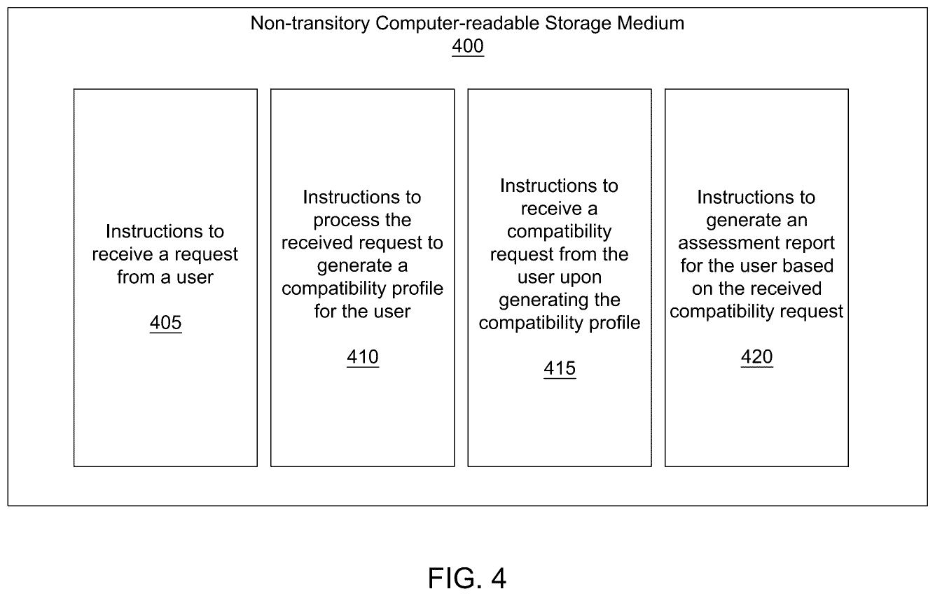

Turning now to FIG. 4, an example non-transitory computer-readable storage medium (CRSM) 400 is shown, in which CRSM 400 comprises instructions executable by the processor 202. The CRSM may comprise any electronic, magnetic, optical, or other physical storage device that stores executable instructions. The instructions may comprise instructions to cause the processor to perform or control performance of operations of the example method 300 and the other methods described herein. For example, the instructions may comprise instructions 405 to receive a request from a user.

In addition, the instructions may comprise instructions 410 to process the received request to generate a compatibility profile for the user. Furthermore, the instructions may comprise instructions 415 to receive a compatibility request from the user upon generating the compatibility profile. Furthermore, the instructions may comprise instructions 420 to generate an assessment report for the user based on the received compatibility request.

The methods described herein may be performed using the systems described herein. In addition, it is contemplated that the methods described herein may be performed using systems different than the systems described herein. Moreover, the systems described herein may perform the methods described herein and may perform or execute the instructions stored in the CRSMs described herein. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

FIG. 5 is a flow diagram illustrating an AI-driven compatibility assessment method, which is executed by the matching engine 102 to evaluate and generate a compatibility report between users. This method enhances matchmaking by leveraging artificial intelligence (AI), machine learning, and natural language processing to analyze user personality traits and predict relationship dynamics.

At step 505, the process begins when a user (Person A) visits the profile of another user (Person B) and may be interested in checking the compatibility. In some embodiments, the Person A is registered with the matching engine 102 using the functionality of the registration module 212.

At step 510, the user (Person A) submits a request to assess compatibility with another user. In some embodiments, the request can be initiated in various ways, including clicking a “Compatibility Check” button on another user's profile. using a voice command (if enabled via the voice-swiping module 220), or by requesting an AI-generated self-assessment to evaluate their own compatibility tendencies. In some embodiments, the request includes personality trait data from both users, which was previously collected during registration or updated within their profile settings. The selected traits are stored in the data repository 106, allowing the system to retrieve and analyze them for compatibility assessment.

At step 515, a decision is made whether the matching engine 102 having an alert model confirms the request for assessment from the user or not. Based on the decision, if the request is declined, the alert is closed, and the user may need to resubmit the request by clicking on access compatibility, as mentioned in step 510. If the request is accepted, the process proceeds to the next step 520.

At step 520, an AI prompt is generated using the profiles of Person A and Person B to generate a relationship compatibility summary. In some embodiments, the matching engine 102 may generate the AI prompt by inputting the profiles of Person A and Person B. In order to input the profiles, the matching engine 102 may retrieve the personality traits of both the user and use them for matching. In some embodiments, the relationship compatibility summary is generated in the context of the big five personality aspects by comparing the personality traits of Person A and Person B. For example, the personality traits associated with Person A are egotistical, controversial, controlling, impatient, stubborn, and vindictive, and the personality traits of Person B are heartless, indecisive, arrogant, egotistical, manipulative, controlling, disorganized, impulsive, and stubborn.

At step 525, an AI response is generated for the AI prompt using the Big Five Personality Traits Model (also known as the Big Five Personality Model). The AI response is generated using the process outlined with respect to FIG. 6.

At step 530, the AI response is processed, and the summary paragraph is extracted. The AI response is generated based on the compatibility analysis using the Big Five Personality Model and is processed to generate a summary paragraph that can be presentable to Person A. The summary paragraph may include a precise description of the compatibility between Person A and Person B.

At step 535, the summary paragraph is displayed to Person A. The summary paragraph is displayed on the user device 104 associated with Person A so that Person A can view the summary paragraph and decide whether to proceed or not.

FIG. 6 illustrates an AI-generated relationship compatibility summary created by the matching engine 102 using the Big Five Personality Traits Model. This model evaluates the compatibility between Person A and Person B by analyzing their personality traits across five key psychological dimensions. By assessing these traits, the matching engine 102 provides an in-depth understanding of potential challenges and dynamics within their relationship.

One of the first dimensions or attributes analyzed is Openness to Experience. Person A is described as controversial, suggesting they are open to unconventional perspectives and thrive on intellectual stimulation. However, Person B is both disorganized and impulsive, indicating a tendency to act without much planning or thought. While this could lead to exciting, spontaneous experiences, it could also create disagreements about how to approach new activities, as Person A might prefer structured exploration while Person B operates more erratically.

The second dimension or attribute, Conscientiousness, plays a significant role in determining how well two individuals can manage responsibilities together. Person A lacks strong organizational skills, and Person B is both disorganized and indecisive. This suggests that neither person is likely to take the lead in structuring plans, managing finances, or handling shared responsibilities. Over time, this lack of conscientiousness could result in frustrations over disorganization and unmet expectations.

When examining the third dimension or attribute, Extraversion, both users display strong self-importance traits, being egotistical, controlling, and arrogant. These traits suggest that both Person A and Person B may seek dominance in their interactions, potentially leading to frequent power struggles. Instead of complementing each other's social dynamics, they might engage in ongoing conflicts over control and decision-making, making it difficult for them to feel valued or heard.

Further, the fourth dimension or attribute, Agreeableness, highlights potential challenges. Both individuals exhibit low agreeableness, characterized by vindictive, stubborn, and manipulative tendencies. This indicates that neither person is likely to compromise easily, and conflicts could escalate rapidly rather than be resolved through mutual understanding. Arguments may become prolonged, with both individuals using manipulative tactics instead of focusing on solutions.

Lastly, the fifth dimension, Neuroticism (Emotional Stability), provides insight into emotional responses and resilience in relationships. Person A is described as impatient and vindictive, suggesting they may struggle with frustration and hold onto resentment. Person B, with their impulsive nature, might make spontaneous decisions that exacerbate conflicts. This combination suggests a relationship that could be marked by emotional intensity, where even minor disagreements trigger disproportionate emotional reactions, making long-term harmony challenging.

Thus, the personality compatibility insights generated using the list of traits and the Big Five Personality Model highlight key areas where Person A and Person B may struggle. Further, a summary is generated using the personality compatibility insights. For example, according to the analysis of the compatibility insights A and B, the summary may include the following: both individuals possess strong dominant traits and low agreeableness, which may lead to power struggles and difficulties in compromise. Their shared tendency towards emotional volatility further increases the likelihood of intensified disagreements. These characteristics suggest that conflicts may arise frequently, with neither individual willing to back down easily.

However, despite these challenges, the summary highlights a potential upside-both individuals may have a deep mutual understanding of each other's need for validation and shared experiences. This could serve as a foundation for emotional connection, allowing moments of bonding despite their strong personalities. Ultimately, effective communication and mutual understanding would be critical for this pairing to overcome their differences and navigate potential pitfalls in their relationship. The analysis suggests that while difficulties may exist, conscious efforts toward self-awareness, compromise, and emotional regulation could improve relationship dynamics.

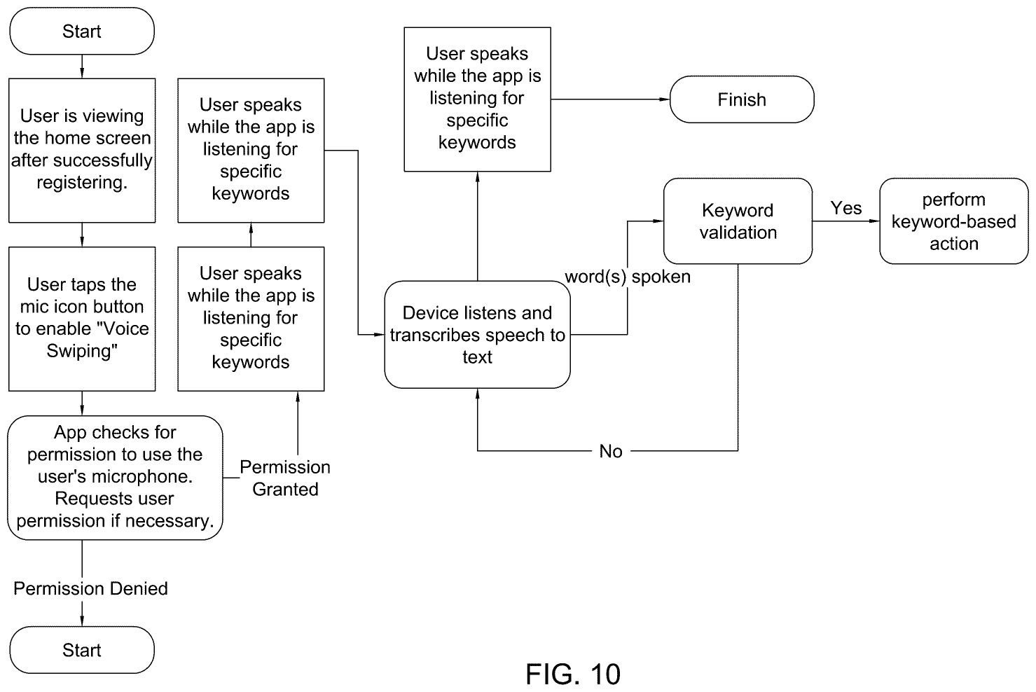

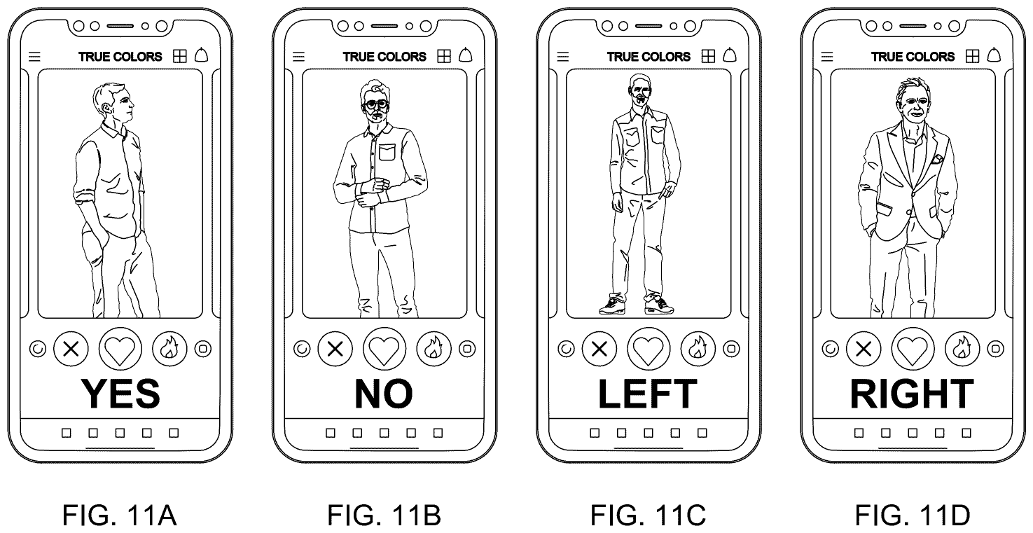

Turning to FIG. 10, another embodiment of the present system includes the option of voice activation software on the user interface of the user device 104 that allows the user to select another user's profile with a vocal command as opposed to using his or her hands. For example, the user device 104 may be provided with a package called, “react-native-voice” which converts speech to text, using platform specific (IOS, Android) speech recognition engine(s). The user device 104 is configured to receive speech-to-text results from “react-native-voice” and use simple logical gates (switch statements) to determine if specific words have been spoken. To utilize this feature in the system, the user would activate the microphone on the user device 104 via a button on the interface, which would enable the voice swiping feature. The software for this feature can be integrated into the overall system to allow for permission control. If the user device 104 contains permission controls, the user will have to grant permission before use. When activated, the user device 104 can include an alert (i.e. a color activation alert or other alert means) that would signal to the user that the microphone is listening for audio commands. If a word spoken matches one of the predefined commands (i.e. “left,” “right,” “yes, “no,” etc.), the voice activation software in the user device 104 is configured to execute this command within the system as shown in FIGS. 11A-D.

The above description of shown example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In some embodiments, the method or methods described above may be executed or carried out by a computing system (for example, the matching engine 102) including a tangible computer-readable storage medium, also described herein as a storage machine, that holds machine-readable instructions executable by a logic machine (e.g., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for matching users in a networking platform hosted by a matching server, the system comprising:
one or more processors; and
one or more memories coupled with the one or more processors and storing processor-executable code that, when executed by the one or more processors, is configured to cause the matching server to:
receive from a user device a request from a user via a networking platform at the user device, wherein the request comprises a selection of one or more personality traits provided on a user interface associated with the networking platform;
process, via a machine learning component integrated with the matching server, the received request to generate a compatibility profile for the user;
receive, from the user device, a compatibility request from the user upon generating the compatibility profile, wherein the compatibility request is provided on the user interface associated with the networking platform;
generate, via the machine learning component integrated with the matching server, an assessment report for the user based on the received compatibility request; and
transmit, to the user device, the generated assessment report, wherein the transmitted generated assessment report is displayed at the networking platform.

2. The system of claim 1, wherein the one or more personality traits are categorized into multiple domains, and wherein each domain corresponds to a particular aspect of personality.

3. The system of claim 1, wherein the compatibility request comprises a self-assessment request.

4. The system of claim 3, wherein the generated assessment report comprises at least one of:
a first group of users that are compatible with the user; and
a second group of users that are not compatible with the user.

5. The system of claim 1, wherein the compatibility request comprises a selection of a target user.

6. The system of claim 1, wherein to generate the assessment report, the one or more memories coupled with the one or more processors and storing processor-executable code that, when executed by the one or more processors, is configured to cause the matching server to
process compatibility profiles of the user and the target user using a machine learning algorithm;
determine a correlation between the user and the target user to one or more personality attributes;
process the determined correlation to a natural language processing to generate compatibility analysis; and
generate the assessment report using the generated compatibility analysis.

7. The system of claim 1, wherein the matching server is configured to process the received request along with data extracted from one or more sources to generate the compatibility profile for the user, wherein the data extracted from the one or more sources comprises social media activity, location history, personal information of the user.

8. A computer-implemented method for matching users in a networking platform by a matching server, the method comprising:
receiving, from a user device and by the matching server, a request from a user via a networking platform at the user device, wherein the request comprises a selection of one or more personality traits provided on a user interface associated with the networking platform;
processing, via a machine learning component integrated with the matching server, the received request to generate a compatibility profile for the user;
receiving, from the user device, a compatibility request from the user upon generating the compatibility profile, wherein the compatibility request is provided on the user interface associated with the networking platform;
generating, via the machine learning component integrated with the matching server, an assessment report for the user based on the received compatibility request; and
transmitting, to the user device, the generated assessment report, wherein the transmitted generated assessment report is displayed at the networking platform.

9. The computer-implemented method of claim 8, wherein the one or more personality traits are categorized into multiple domains, and wherein each domain corresponds to a particular aspect of personality, and wherein at least one of: the request and the compatibility request is an audio input request.

10. The computer-implemented method of claim 8, wherein the compatibility request comprises a self-assessment request.

11. The computer-implemented method of claim 10, wherein the generated assessment report comprises at least one of:
a first group of users that are compatible with the user; and
a second group of users that are not compatible with the user.

12. The computer-implemented method of claim 8, wherein the compatibility request comprises a selection of a target user.

13. The computer-implemented method of claim 8, wherein generating the assessment report comprises:
processing compatibility profiles of the user and the target user using a machine learning algorithm;
determining a correlation between the user and the target user to one or more personality attributes;
processing the determined correlation to a natural language processing to generate compatibility analysis; and
generating the assessment report using the generated compatibility analysis.

14. The computer-implemented method of claim 8, wherein the received request is processed along with data extracted from one or more sources to generate the compatibility profile for the user, wherein the data extracted from the one or more sources comprises social media activity, location history, personal information of the user.

15. A computer readable storage medium having data stored therein representing software executable by a computer, the software comprising instructions that, when executed, cause the computer readable storage medium to perform:
receiving, from a user device and by a matching server, a request from a user via a networking platform at the user device, wherein the request comprises a selection of one or more personality traits provided on a user interface associated with the networking platform;
processing, via a machine learning component integrated with the matching server, the received request to generate a compatibility profile for the user;
receiving, from the user device, a compatibility request from the user upon generating the compatibility profile, wherein the compatibility request is provided on the user interface associated with the networking platform;
generating, via the machine learning component integrated with the matching server, an assessment report for the user based on the received compatibility request; and
transmitting, to the user device, the generated assessment report, wherein the transmitted generated assessment report is displayed at the networking platform.

16. The computer readable storage medium of claim 15, wherein the one or more personality traits are categorized into multiple domains, and wherein each domain corresponds a particular aspect of personality.

17. The computer readable storage medium of claim 15, wherein the compatibility request comprises a self-assessment request.

18. The computer readable storage medium of claim 17, wherein the generated assessment report comprises at least one of:
a first group of users that are compatible with the user; and
a second group of users that are not compatible with the user.

19. The computer readable storage medium of claim 15, wherein the compatibility request comprises a selection of a target user.

20. The computer readable storage medium of claim 15, wherein generating the assessment report comprises:
processing compatibility profiles of the user and the target user using a machine learning algorithm;
determining a correlation between the user and the target user to one or more personality attributes;
processing the determined correlation to a natural language processing to generate compatibility analysis; and
generating the assessment report using the generated compatibility analysis.
